(19) United States
(12) Patent Application Publication
(10) Pub. No.: US 2009/0243254 A1
(43) Pub. Date: Oct. 1, 2009

(54) Intelligent bicycle and front fork thereof

(75) Inventors: Dar-Ming Chiang, Hsinchu City (TW); Shu-Ru Lin, Taichung County (TW); Jaw-Min Pern, Hsinchu County (TW); Sheng-Long Liang, Hsinchu City (TW); Cheih-Fu Tseng, Kaohsiung City (TW)

Correspondence Address: BACON & THOMAS, PLLC, 625 SLATERS LANE, FOURTH FLOOR, ALEXANDRIA, VA, 22314-1176, US

(73) Assignee: Industrial Technology Research Institute, Hsinchu (TW)

(21) Appl. No.: 12/379,959

(22) Filed: Mar. 5, 2009

(30) Foreign Application Priority Data
Mar. 31, 2008 (TW) 97111655

(51) Int. Cl. B62K 3/02; H02N 2/18

(52) U.S. Cl. 280/281.1; 310/339

(57) ABSTRACT

The present invention provides an intelligent bicycle and the front fork thereof, in which piezoelectric elements are provided on a position of a bicycle front fork or frame having vibration amplitude greater than a set value under a vibration frequency. By converting of direct and converse piezoelectric effect by the designed circuit modules integrated on the front fork or frame, the intelligent bicycle according to the present invention is provided with functions of energy storage and vibration suppression.

### BACKGROUND OF THE INVENTION

1. Field of the Invention

The present invention relates to a bicycle, and more particularly to an intelligent bicycle and front fork thereof having the functions of energy storage and vibration suppression.

2. Description of the Related Art

With the rapid development of technologies and the increasing life quality, sports and recreational activities have become more and more popular. Recently, bicycle sports are as well welcome among these activities. The population of cyclists distributes over various groups despite their ages and genders. Also, for the issues of environment protection and the increasing oil price, more and more people have preferred riding bicycles for their communication.

Taiwan is one of the major bicycle manufacturing countries. To compete with other bicycle manufacturing countries, especially China and India, the manufactures in Taiwan have been putting a lot of efforts in developing high quality bicycles. Novel materials, technologies and fabrication process have been adopted to improve the quality and the production rate of bicycle frame and front fork. Among the novel materials, carbon fiber composite material is advantageous of its low density, high flexibility and tenacity, so it is widely welcome on the market.

It is inevitable that the bicycle wheels would hit the ground and then vibrate, especially when riding on off-roads, or rough roads having holes and bumps. The intensive vibration makes rider feel uncomfortable. Besides, the lighting for bicycling at night is also a problem for riders. A brighter lamp requires a higher power source. But the available batteries on market are not good enough due to the problems of their volume, weight and lifetime.

U.S. Pat. No. 6,986,521 disclosed a vibration suppressed bicycle structure, in which piezoelectric elements are provided on a bicycle frame and a handle set to convert the vibration energy of the bicycle into electric energy. However, the electric energy produced from the piezoelectric elements are not further stored and used.

For overcoming the mentioned issues, it is desirable to develop a bicycle having the functions of both vibration suppression and energy storage.

### SUMMARY OF THE INVENTION

It is one aspect of the present invention to provide a bicycle front fork with the functions of vibration suppression and energy storage via the electromechanical coupling effects of piezoelectric elements. Accordingly, when the bicycle front fork receives a mechanical energy and then vibrates and deforms, the direct piezoelectric effect of piezoelectric elements converts the mechanical energy of vibration and deformation into electrical energy, hence provides a voltage to achieve vibration suppression. The electrical energy produced therefrom is then stored by a designed circuit module to be further used (such as providing the lighting of bicycling at night).

It is another aspect of the present invention to provide an intelligent bicycle. When the bicycle receives a mechanical energy and then vibrates and deforms, the direct piezoelectric effect of a piezoelectric element converts the mechanical energy of vibration into electrical energy, hence provides a voltage. An energy storage device receives the voltage and then output to another piezoelectric element. The second piezoelectric element receives the electrical energy and produces a motion against the vibration of the bicycle by converse piezoelectric effect, so the vibration of the bicycle is then further suppressed. Additionally, if the electrical energy were transferred to the reversal voltage of the other piezoelectric element, the converse piezoelectric effect thereof produces a motion in parallel with the vibration of the bicycle, so the energy for uphill climbing would not be consumed by the piezoelectric element.

According to the aspects of the present invention, the bicycle front fork comprises: a front fork construction receiving a mechanical energy and producing a first vibration in response thereto; a first piezoelectric element on a position of said front fork construction, on which said front fork construction produces a vibration having an amplitude greater than a set value under a vibration frequency, wherein said first piezoelectric element produces a first voltage in response said first vibration; and a circuit module coupled to said first piezoelectric element to receive and output said first voltage.

Additionally, said circuit module comprises an energy storage module to receive said first voltage. Said first piezoelectric element is located on one of an outer face and an inner face of said front fork construction. Said circuit module further comprises: a second piezoelectric element; and a control module controlling said energy storage module to output a second voltage to said second piezoelectric element, wherein said second piezoelectric element produces a second vibration in response to second voltage. Said second piezoelectric is located on one of an outer face and an inner face of said front fork construction. The respective polar directions of said first piezoelectric element and said second piezoelectric element are arranged identically or reversely. Said control module comprises a switch to switch the direction of said second voltage to said second piezoelectric element.

According to the aspects of the present invention, the intelligent bicycle comprises: a bicycle frame receiving a mechanical energy and producing a first vibration in response thereto, wherein said bicycle frame comprises a frame body and a front fork construction connected to a front part of said frame body; a first piezoelectric element on a position of said bicycle frame on which said bicycle frame produces a vibration having an amplitude greater than a set value under a vibration frequency, wherein said first piezoelectric element produces a first voltage in response said first vibration; and a circuit module coupled to said first piezoelectric element to receive and output said first voltage.

Additionally, said first piezoelectric element is located on one of said frame body and said front fork construction. Said first piezoelectric element is located on one of an outer face and an inner face of said bicycle frame. Said circuit comprises an energy storage module to reserve said first voltage. Said circuit module further comprises: a second piezoelectric element; and a control module controlling said energy storage module to output a second voltage to said second piezoelectric element, wherein said second piezoelectric element produces a second vibration in response to said second voltage. Said second piezoelectric element is located on one of an outer face and an inner face of said bicycle frame. Said second piezoelectric element is located on one of said frame body and said front fork construction. Said control module comprises a switch to switch the direction of said second voltage to said second piezoelectric element. The respective polar directions of said first piezoelectric element and said second piezoelectric element are arranged identically or reversely.

In summary, the bicycle front fork and intelligent bicycle of the present invention have piezoelectric elements and circuit module, which could receive the mechanical energy from the impact between bicycle wheels and the ground, and then convert the energy of vibration and deformation thereof into electrical energy to output a voltage via direct piezoelectric effect of piezoelectric elements. Therefore, the vibration of bicycle is then reduced by consuming the energy thereof. Additionally, a circuit module is used to further feedback-control the vibration or for other applications.

### BRIEF DESCRIPTION OF THE DRAWINGS

The above objects and advantages of the present invention will become more readily apparent to those ordinarily skilled in the art after reviewing the following detailed descriptions and accompanying drawings, in which:

FIG. 1 schematically shows a bicycle front fork in accordance with an embodiment of the present invention;

FIG. 2 schematically shows a bicycle front fork in accordance with an embodiment of the present invention, wherein piezoelectric elements are located outside the front fork construction;

FIG. 3 shows an energy storage module in accordance with an embodiment of the present invention;

FIG. 4 shows the relationship between amplitude and vibration position of a conventional bicycle front fork (without vibration suppression) under different vibration frequencies;

FIG. 5 shows the result of vibration suppression test of a bicycle front fork in accordance with an embodiment of the present invention (having only a first piezoelectric element, without feedback control), which illustrates the vibration decay at a position 15 cm away from the free floating end (center of the front fork handle), wherein the gray part represents the vibration decay of a bicycle front fork of the present invention, and black part represents the vibration decay of a conventional bicycle front fork (without vibration suppression);

FIG. 6 shows the result of vibration suppression test of a bicycle front fork in accordance with an embodiment of the present invention (having only a first piezoelectric element, without feedback control), which illustrates the vibration frequency response curve at a position 15 cm away from the free floating end (center of the front fork handle), wherein the dotted line represents the response curve of a bicycle front fork of the present invention, and the solid line represents the response curve of a conventional bicycle front fork (without vibration suppression);

FIG. 7 shows the result of vibration suppression test of a bicycle front fork in accordance with an embodiment of the present invention (having a first piezoelectric element and a second piezoelectric element in parallel, with feedback control), which illustrates the vibration decay at a position 15 cm away from the free floating end (center of the front fork handle), wherein the gray part represents the vibration decay of a bicycle front fork of the present invention with feedback control, and black part represents the vibration decay of a bicycle front fork of the present invention without feedback control;

FIG. 8 shows the result of vibration suppression test of a bicycle front fork in accordance with an embodiment of the present invention (having a first piezoelectric element and a second piezoelectric element in parallel, with feedback control), which illustrates the vibration frequency response curve at a position 15 cm away from the free floating end (center of the front fork handle), wherein the dotted line represents the response curve of a bicycle front fork of the present invention with feedback control, and the solid line represents the response curve of a bicycle front fork of the present invention without feedback control; and

FIG. 9 schematically shows a frame body in accordance with an embodiment of the present invention;

### DETAILED DESCRIPTION OF THE EMBODIMENT

With reference to the following disclosures combined with the accompanying drawings, the sensory structure of capacitive touch panel according to the present invention is illustrated and understood. It should be noted that the accompanying drawings are provided only for illustration where the size or scale of the elements shown therein are not necessarily the actual one.

The present invention provides an intelligent bicycle with the functions of vibration suppression and energy storage. Piezoelectric elements are provided on the bicycle frame and front fork to convert mechanical energy of vibration into electrical energy, and a circuit module is used to store the electrical energy or further suppress the vibration.

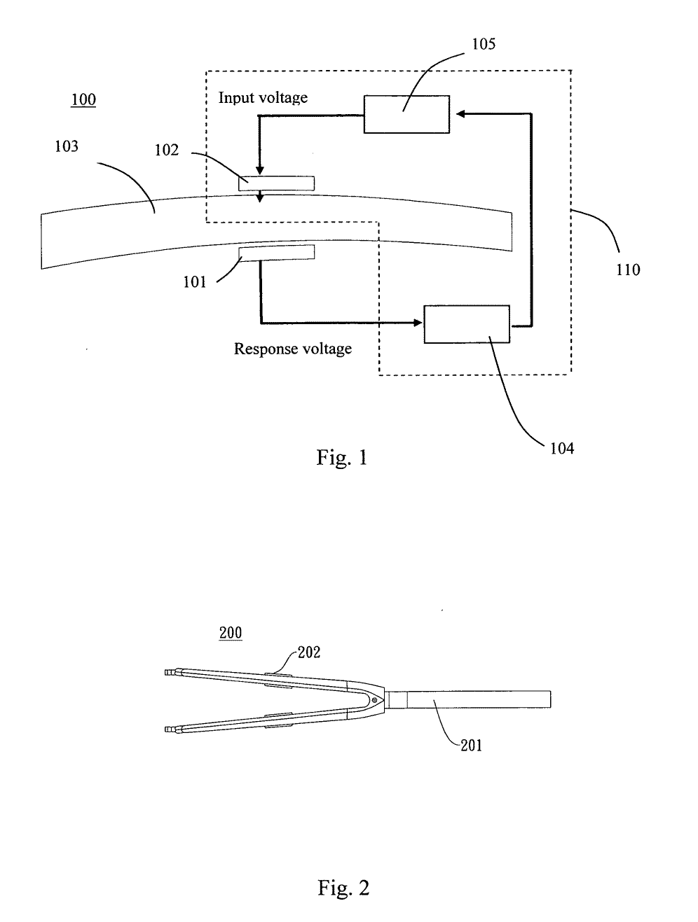

With reference to FIG. 1, the bicycle front fork according to an embodiment of the present invention is schematically illustrated. As shown in FIG. 1, the bicycle front fork of the present invention 100 is constructed by a front fork construction 103 bearing a mechanical energy and producing a first vibration in response thereto. On the front fork construction 103, a first piezoelectric element 101 is located on a position on which the front fork construction 103 produces a vibration greater than a set value under a vibration frequency. The first piezoelectric element 101 produces a first voltage in response to the first vibration, and the circuit module 110 coupled to the first piezoelectric element 101 receives the first voltage and generates an output corresponding thereto. The circuit module 110 further includes an energy storage module 104 to reserve the energy corresponding to the first voltage, and includes a second piezoelectric element 102 and a control module 105, wherein the control module 105 operates to control the energy storage module 104 to output a second voltage to the second piezoelectric element 102, so that the second piezoelectric element 102 may produce a second vibration in response thereto. Additionally, the control module 105 includes a switch to switch the direction of the second voltage provided to the second piezoelectric element 102.

When the respective polar directions of the first piezoelectric element 101 and the second piezoelectric element 102 are arranged identically, they have the same direction of polarization. Therefore, by switching the switch of control module 105, the positive pole of first piezoelectric element 101 is connected to another positive pole thereof, and the negative pole of first piezoelectric element 101 is connected to another negative pole thereof. The voltage reserved in the energy storage module 104 is feedback-coupled to the second piezoelectric element 102 as a second voltage, which is equivalent to parallel first piezoelectric element 101 and second piezoelectric element 102. In this case, the second piezoelectric element 102 is used as an actuator. The second voltage provided by the energy storage module 104 allows the second piezoelectric element 102 to produce a vibration against the vibration of the front fork construction 103, so that the vibration is then further suppressed.

Similarly, by switching the switch of control module 105, the positive pole and the negative pole of first piezoelectric element 101 is connected to each other alternatively and then coupled to the second piezoelectric element 102, which is equivalent to series connect first piezoelectric element 101 and second piezoelectric element 102. So the voltages produced by first piezoelectric element 101 and second piezoelectric element 102 are both reserved to achieve good energy storage.

In the present invention, the front fork construction 103 is made of aluminum alloy, titanium alloy, steel alloy or composite materials (such as carbon fiber composite material). The first piezoelectric element 101 and the second piezoelectric element 102 are made of single crystal piezoelectric material (such as quartz, lithium niobate, lithium tantalate and etc), thin film piezoelectric material (such as zinc oxide), polymer piezoelectric material (such as polyvinylidene difluoride (PVDF)), ceramic piezoelectric material (such as barium titanate, lead zirconate titanate and etc) or the composite material thereof.

The first piezoelectric element 101 and the second piezoelectric element 102 are combined with the front fork construction 103 by adhering outside of the front fork construction 103, placing in the grooves of the front fork construction 103 or embedding in the inner pipe of the front fork construction 103. When the front fork construction 103 is made of composite materials, the first piezoelectric element 101 and the second piezoelectric element 102 could be buried inside the layers of the composite materials.

With reference to FIG. 2, the bicycle front fork in accordance with an embodiment of the present invention is schematically illustrated. As shown in FIG. 2, the bicycle front fork 200 of the present invention is constructed by a front fork construction 201, at least one first piezoelectric element 202 and a circuit module (not shown). The front fork construction 201 is the main structure that bears the mechanical energy of impact between bicycle and ground, and produces a vibration. The first piezoelectric element 202 is adhered on the outer surface of the front fork construction 201. As front fork construction 201 vibrates and deforms, the first piezoelectric element 202 converts the mechanical energy of vibration into electrical energy and produces a first voltage to consume the mechanical energy and suppress vibration. In other embodiments, it is also feasible to adhere or embed piezoelectric elements in the inner face of the front fork construction 201.

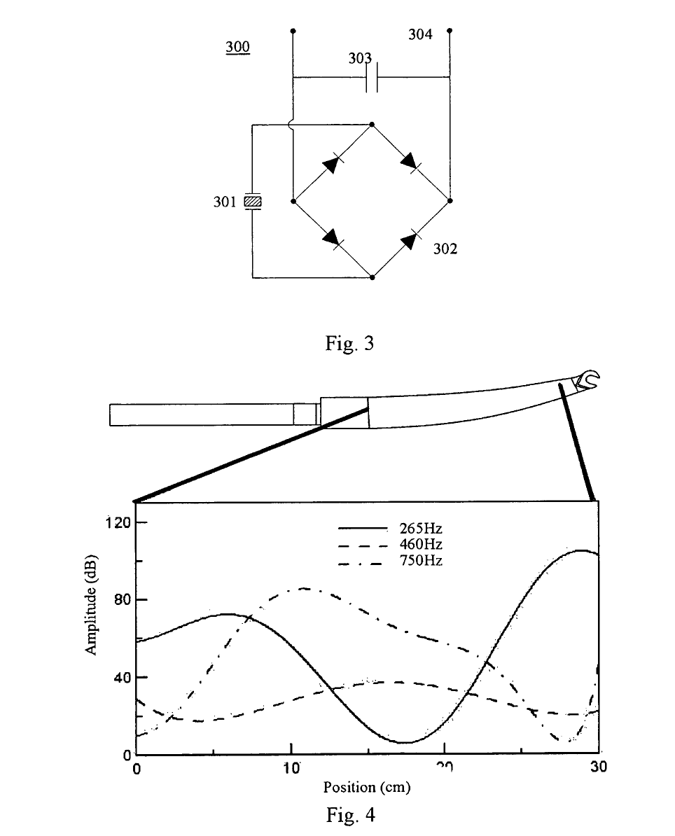

With reference to FIG. 3, the energy storage module in accordance to an embodiment of the present invention is schematically illustrated. As shown in FIG. 3, the energy storage module 300 includes a bridge diode rectifier 302, a capacitor 303 and an energy storage battery 304, wherein the bridge diode rectifier 302 is connected to a first piezoelectric element 301. The energy storage module 300 receive a first voltage produced by converting mechanical energy into electrical energy via direct piezoelectric effect, which is that the first voltage produced by the first piezoelectric element 301 is transferred to the bridge diode rectifier 302 to produce a direct current by rectification, and then output to the capacitor 303. The electrical energy is stored in the capacitor 303 temporarily, and then output and stored in the energy storage battery 304. The bridge diode rectifier 302 includes four diodes, and the connection thereof is shown in FIG. 4. The capacity of capacitor 303 matches the first voltage. The energy storage battery 304 could be rechargeable batteries such as nickel-metal hydride batteries, lithium battery and etc. By using energy storage module 300, the mechanical energy of the vibration of bicycle is converted into electrical energy by the first piezoelectric element 301, and then stored in the energy storage battery 304. The electrical energy reserved could be further used in vibration suppression or for other applications (such as the lighting for night bicycling).

In order to find a suitable position on the bicycle front fork construction to install the first piezoelectric element and achieve good vibration suppression, FIG. 4 shows the relationship between amplitude and vibration position of a conventional bicycle front fork (without vibration suppression) under different vibration frequencies. In the present embodiment, the total weight of the bicycle front fork is 510.2 g, including two handles made by 33 cm carbon fiber material and a front fork made by a 30 cm aluminum alloy vertical tube. Under the vibration frequency of 750 Hz, at the position of 5 to 20 cm away from the vertical tube and along the direction of two handles has greater amplitude. Therefore, better vibration suppression could be achieved by placing piezoelectric element on these positions having greater amplitude.

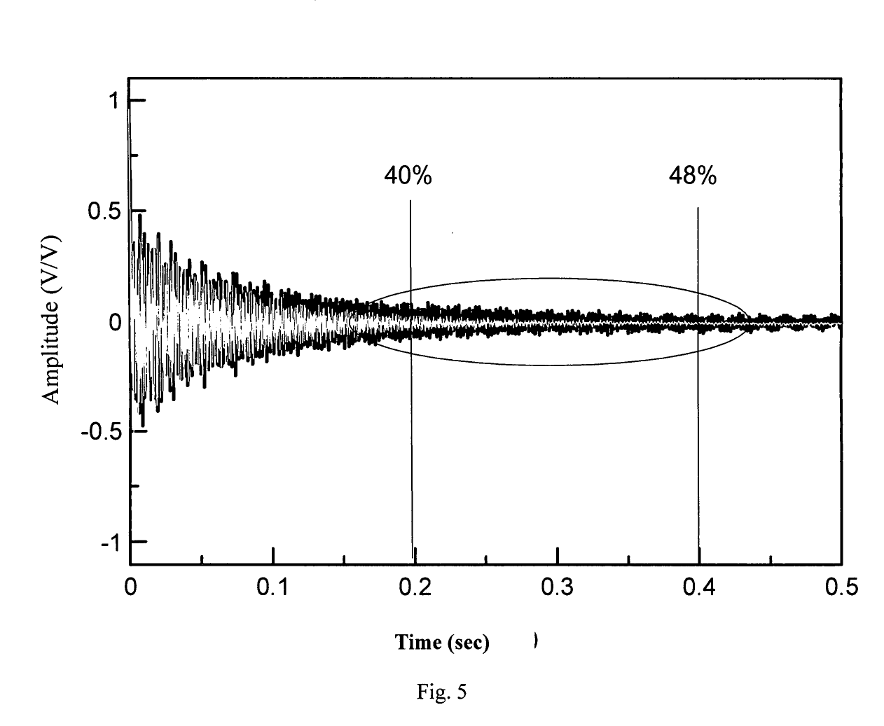

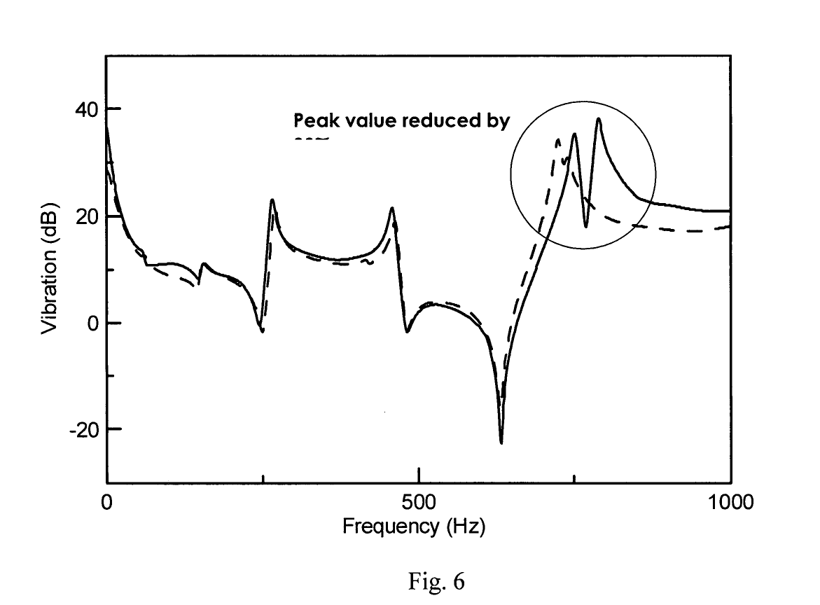

With reference to FIG. 5 and FIG. 6, the result of vibration suppression test of a bicycle front fork in accordance with an embodiment of the present invention (having only a first piezoelectric element, without feedback control) is illustrated by the vibration decay and vibration frequency response curves at a position 15 cm away from the free floating end (center of the front fork handle). In FIG. 5, the gray part represents the vibration decay of a bicycle front fork of the present invention (without feedback control), and black part represents the vibration decay of a conventional bicycle front fork (without vibration suppression). At the time of 0.2 second and 0.4 second, the amplitude of bicycle front fork of the present invention (without feedback control) decays to be 40% and 48% of that of the conventional bicycle front fork. In FIG. 6, dotted line represents the response curve of bicycle front fork of the present invention, and solid line represents the response curve of a conventional bicycle front fork. The unit of vibration response curve is dB, and the value thereof is calculated by below equation:

dBv=20 log₁₀(v)

wherein v is the amplitude at the measurement point of bicycle front fork, and dBv is logarithmic amplitude. Comparing the greatest amplitude produced by both of those front forks, the peak amplitude of bicycle front fork of the present invention (without feedback control) is reduced by 20%. From FIG. 5 and FIG. 6, it is obvious that the bicycle front fork of the present invention effectively reduces the amplitude of vibration compared to the conventional bicycle front fork.

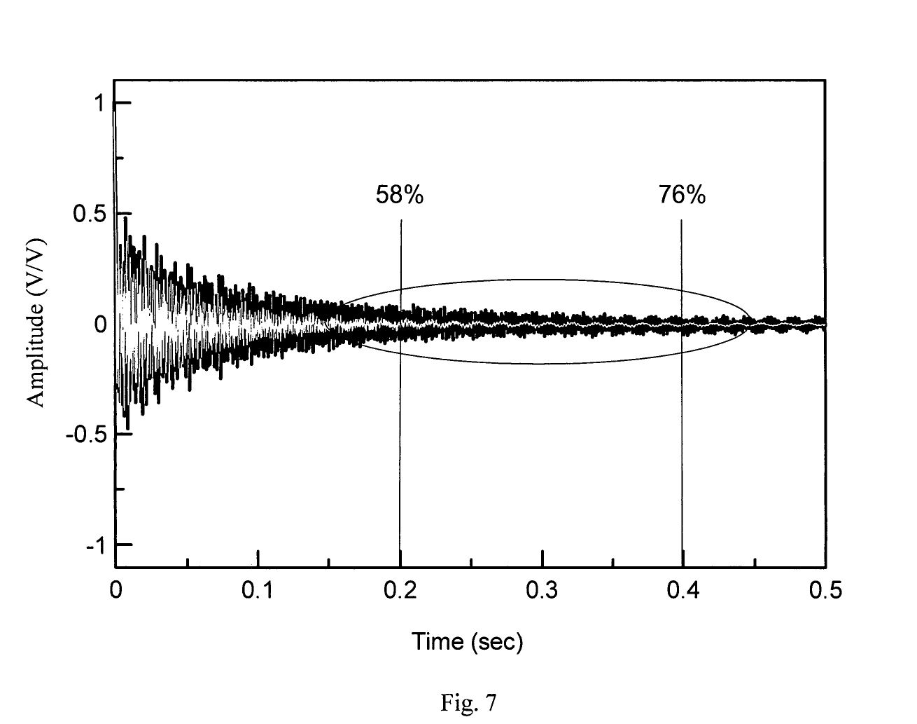

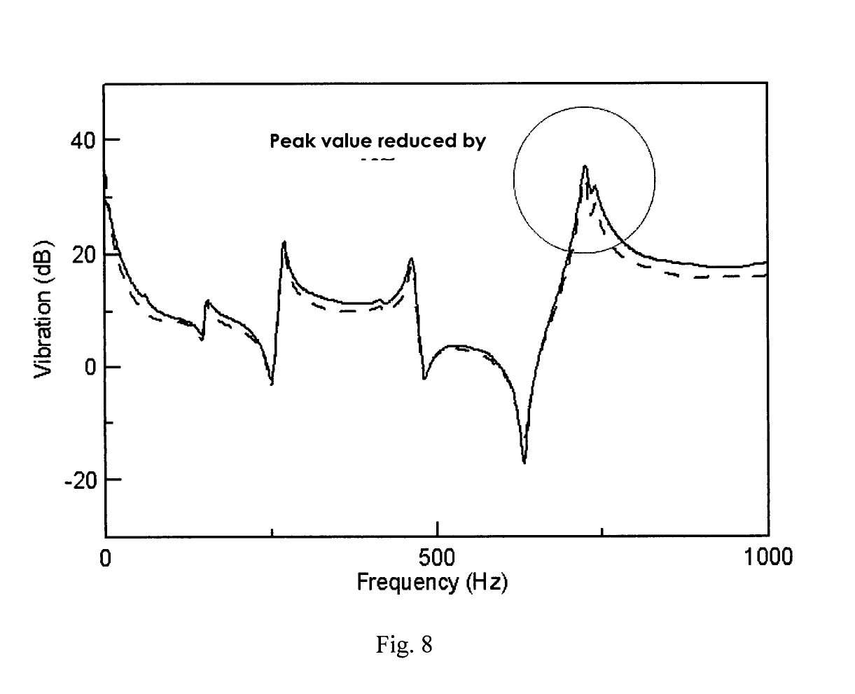

With the reference of following FIG. 7 and FIG. 8, the result of vibration suppression test of a bicycle front fork in accordance with an embodiment of the present invention (having a first piezoelectric element and a second piezoelectric in parallel, with feedback control) is illustrated by the vibration decay and vibration frequency response curves at a position 15 cm away from the free floating end (center of the front fork handle). In FIG. 7, the gray part represents the vibration decay of a bicycle front fork of the present invention (having a first piezoelectric element and a second piezoelectric in parallel, with feedback control), and black part represents the vibration decay of a bicycle front fork of the present invention (having only a first piezoelectric element, without feedback control). At the time of 0.2 second and 0.4 second, the amplitude of front fork with feedback control of the present invention decays to be 58% and 78% of that of the front fork without feedback control of the present invention. In FIG. 8, dotted line represents the response curve of front fork with feedback control of the present invention, and solid line represents the front fork without feedback control of the present invention. Comparing the greatest amplitude produced by both of those front forks, the peak amplitude of bicycle front fork with feedback control of the present invention is reduced by 12%. It is known from FIG. 7 and FIG. 8, by using the direct and converse piezoelectric effects of piezoelectric element, the electrical energy produced from the first piezoelectric element is provided to the second piezoelectric element, and then a second vibration is produced to oppose the first vibration of first piezoelectric element, hence achieve the vibration suppression effect. The feedback control obviously and effectively reduces the amplitude of vibration.

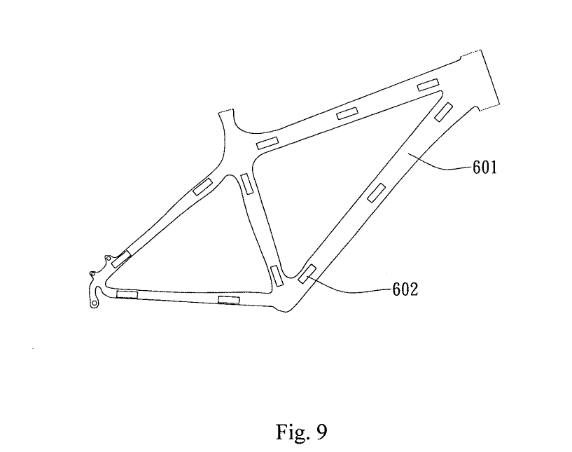

In order to increase the efficiency of the energy storage module, besides the bicycle front fork, piezoelectric elements are also provided on the bicycle frame body. FIG. 9 schematically shows a bicycle frame body in accordance with an embodiment of the present invention, wherein piezoelectric elements are adhered outside the frame body. As shown in FIG. 9, plural first piezoelectric elements 602 are adhered on a frame body 601. The frame body 601 is the main structure of a bicycle, which receives the mechanical energy of the impact between the bicycle and ground, and produces a vibration. The first piezoelectric elements 602 are adhered outside the frame body 601. As the frame body 601 vibrates, the first piezoelectric elements 602 convert the mechanical energy of vibration into electrical energy, and the electrical energy is output and then stored in the energy storage battery 304 of energy storage module 300 as shown in FIG. 3. In this manner, the bicycle front fork of the present invention as shown in FIG. 1 could also be replaced by a bicycle frame or frame body to achieve the functions of vibration suppression and energy storage.

Similarly, the frame body 601 is made of aluminum alloy, titanium alloy, steel alloy or composite materials (such as carbon fiber composite material). The first piezoelectric elements 602 are provided on the frame body 601 by placing in the grooves of the frame body 601 or embedding on the inner pipe of the frame body 601. When the frame body 601 is made of composite materials, the first piezoelectric elements 602 could be buried inside the layers of the composite materials.

The following example illustrates the installation of piezoelectric elements of the present invention. In the present embodiment, piezoelectric elements are installed by outside-adhering, inside-burying or covering, among which outside-adhering has less influence to the fabrication process of bicycle frame body and front fork construction. This embodiment simply describes the outside-adhering process of piezoelectric element. The material of the present embodiment includes: four piezoelectric strips 50 mm×8 mm×0.6 mm; conductive copper foil 110 mm×3 mm×14 μm; and two glass fiber/epoxy prepregs 110 mm×10 mm.

### Fabrication Process of the Present Embodiment:

Step 1: covering a copper foil on a glass fiber prepreg.
Step 2: placing two piezoelectric strips on the copper foil.
Step 3: again placing a copper foil on each of the piezoelectric strips, applying insulating materials between the piezoelectric strips to separate the upper and lower copper foils.
Step 4: covering another glass fiber pregreg on the copper foil.
Step 5: laying in hot press, applying a pressure of 2 kg/cm², and heating in a environment of 135° C. for 30 minutes. The complete piezoelectric element is obtained after cooling.
Step 6: applying solvent-type epoxy resin of 130° C. curing temperature onto the surface of the piezoelectric element, and then evaporating and drying the solvent.
Step 7: installing the piezoelectric element on a suitable position of bicycle front fork or frame by jig.
Step 8: placing in oven at 130° C. for 30 minutes to complete the assembling process of outside-adhering piezoelectric element.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

What is claimed is:

1. A bicycle front fork comprising:
a front fork construction bearing a mechanical energy and producing a first vibration in response thereto;
a first piezoelectric element located on said front fork construction at a position on which said front fork construction produces a vibration having an amplitude greater than a set value under a vibration frequency, wherein said first piezoelectric element produces a first voltage in response to said first vibration; and
a circuit module coupled to said first piezoelectric element to receive said first voltage and produce an output corresponding thereto.

2. The bicycle front fork of claim 1, wherein said circuit module comprises an energy storage module to reserve an energy corresponding to said first voltage.

3. The bicycle front fork of claim 1, wherein said first piezoelectric element is located on one of an outer face and an inner face of said front fork construction.

4. The bicycle front fork of claim 2, wherein said circuit module further comprises:
a second piezoelectric element; and
a control module controlling said energy storage module to provide said second piezoelectric element with a second voltage, wherein said second piezoelectric element produces a second vibration in response to said second voltage.

5. The bicycle front fork of claim 4, wherein said second piezoelectric element is located on one of an outer face and an inner face of said front fork construction.

6. The bicycle front fork of claim 4, wherein the respective polar directions of said first piezoelectric element and said second piezoelectric element are arranged identically.

7. The bicycle front fork of claim 4, wherein the respective polar directions of said first piezoelectric element and said second piezoelectric element are arranged reversely.

8. The bicycle front fork of claim 4, wherein said control module comprises a switch to switch the direction of said second voltage provided to said second piezoelectric element.

9. An intelligent bicycle comprising:
a bicycle frame bearing a mechanical energy and producing a first vibration in response thereto, wherein said bicycle frame comprises:
a frame body; and
a front fork construction connected to a front part of said frame body;
a first piezoelectric element located on said bicycle frame at a position on which said bicycle frame produces a vibration having an amplitude greater than a set value under a vibration frequency, wherein said first piezoelectric element produces a first voltage in response to said first vibration; and
a circuit module coupled to said first piezoelectric element to receive said first voltage and produce an output corresponding thereto.

10. The intelligent bicycle of claim 9, wherein said first piezoelectric element is located on one of said frame body and said front fork construction.

11. The intelligent bicycle of claim 9, wherein said first piezoelectric element is provided correspondingly on an outer face or an inner face of said bicycle frame.

12. The intelligent bicycle of claim 9, wherein said circuit module comprises an energy storage module to reserve an energy corresponding to said first voltage.

13. The intelligent bicycle of claim 12, wherein said circuit module further comprises:
a second piezoelectric element; and
a control module controlling said energy storage module to provide said second piezoelectric element with a second voltage, wherein said second piezoelectric element produces a second vibration in response to said second voltage.

14. The intelligent bicycle of claim 13, wherein said second piezoelectric element is located on one of an outer face and an inner face of said bicycle frame.

15. The intelligent bicycle of claim 13, wherein said second piezoelectric element is located on one of said frame body and said front fork construction.

16. The intelligent bicycle of claim 13, wherein said control module comprises a switch to switch the direction of said second voltage provided to said second piezoelectric element.

17. The intelligent bicycle of claim 13, wherein the respective polar directions of said first piezoelectric element and said second piezoelectric element are arranged identically.

18. The intelligent bicycle of claim 13, wherein the respective polar directions of said first piezoelectric element and said second piezoelectric element are arranged reversely.
